(19) United States
(12) Patent Application Publication
(10) Pub. No.: US 2020/0386651 A1
(43) Pub. Date: Dec. 10, 2020

(54) AUTOMATIC MACHINE HEALTH ASSESSMENT SYSTEM FOR ASSESSING HEALTH OF A MACHINING TOOL

(71) Applicant: Ford Motor Company, Dearborn, MI (US)

(72) Inventors: Richard James Furness, Ann Arbor, MI (US); Youssef Ziada, Milford, MI (US); David Alan Stephenson, Detroit, MI (US)

(73) Assignee: Ford Motor Company, Dearborn, MI (US)

(21) Appl. No.: 16/930,413

(22) Filed: Jul. 16, 2020

Related U.S. Application Data
(63) Continuation-in-part of application No. 15/729,579, filed on Oct. 10, 2017, now Pat. No. 10,753,823.

(51) Int. Cl. G01M 7/02; G01H 1/00

(52) U.S. Cl. CPC G01M 7/022; B23Q 15/007; G01H 1/003; G01M 7/025

(57) ABSTRACT

A machine assessment system of the present disclosure is for a machining tool including a spindle. The machine assessment system includes a calibrated spindle tool configured to couple to a distal end of the spindle, a displacement sensor configured to measure a performance characteristic of the machining tool based on a controlled excitation of the calibrated spindle tool, and a controller communicably coupled to the displacement sensor to acquire the performance characteristic. In measuring the performance characteristic, the displacement sensor is detached from the calibrated spindle tool. The controller is configured perform a machine health assessment based on the performance characteristic.

### CROSS-REFERENCE

This application is a continuation-in-part of U.S. application Ser. No. 15/729,579 filed Oct. 10, 2017. The disclosure of the above application is incorporated herein by reference.

### FIELD

The present disclosure relates to a system for measuring a dynamic response of a machine.

### BACKGROUND

The statements in this section merely provide background information related to the present disclosure and may not constitute prior art.

Computer numeric control (CNC) machines are operable to perform high speed machining of workpieces, such as aluminum blocks, to form a high precision parts, such as engine blocks. When machining at high cutting speeds, especially with thin walled workpieces, structural dynamics and calibration of the CNC machine can affect the quality of the part. Specifically, overtime, machine offset conditions such as unstable vibration, axial misalignment, and/or spindle runout may occur and affect the precision of the machining process and thus, the quality of the part.

Currently manual offline testing is used to calibrate and troubleshoot unstable vibrations. For example, with the CNC machine being offline, an operator strikes the CNC machine with an instrumented hammer at one or more points along the machine and vibrations measurements are taken using accelerometers. This operation is subject to operator error and can result in inaccuracies due to an unknown and varying force applied to the machine.

Furthermore, the wear and tear of a tool used by the CNC machine is largely unknown, and periodic preventative maintenance is required. This incurs expensive costs as components with significant remaining life are replaced, machine tools are taken out of service and operators are tied up in unnecessary maintenance. These and other issues are addressed by the teachings of the present disclosure.

### SUMMARY

This section provides a general summary of the disclosure, and is not a comprehensive disclosure of its full scope or all of its features.

In one form, the present disclosure is directed toward a machine assessment system for a machining tool including a spindle. The machine assessment system includes a calibrated spindle tool configured to couple to a distal end of the spindle, a displacement sensor configured to measure a performance characteristic of the machining tool based on a controlled excitation of the calibrated spindle tool, and a controller communicably coupled to the displacement sensor to acquire the performance characteristic. In measuring the performance characteristic, the displacement sensor is detached from the calibrated spindle tool. The controller is configured perform a machine health assessment based on the performance characteristic.

In another form, the machine assessment system further includes a vibration mechanism operable to exert the controlled excitation to the calibrated spindle tool.

In yet another form, the vibration mechanism includes a mechanical impactor operable to exert a physical force upon the calibrated spindle tool, an actuation device configured to operate the mechanical impactor, and a load cell disposed at the mechanical impactor to measure an excitation signal indicative of the physical force. The actuation device energizes the mechanical impactor to have the mechanical impactor exert the physical force, and the load cell is communicably coupled to the controller to provide the excitation signal.

In one form, the actuation device includes a solenoid energizeable by a power supply to trigger the mechanical impactor to exert the physical force in response to being energized.

In another form, the actuation device includes a spring to trigger the mechanical impactor to exert the physical force in response to being energized.

In yet another form, the performance characteristic of the machining tool is indicative of a vibrational response of the machining tool due to the physical force exerted by the mechanical impactor.

In one form, the mechanical impactor includes at least one of a mechanical spring, a hydraulic pump, and an electronic actuator.

In another form, the machine assessment system further includes a power supply configured to provide power to at least one of the controller and the displacement sensor.

In yet another form, the machine assessment system further includes a fixture configured to support at least one of the controller, the displacement sensor, and the calibrated spindle tool. The fixture is configured to mount at the machining tool for the machine health assessment.

In one form, the calibrated spindle tool is a mandrel to perform at least one of alignment assessment and spindle runout assessment of the machining tool.

In another form, the calibrated spindle tool is a tool artifact to perform a dynamic vibration assessment of the machining tool. The tool artifact has a known mass and damping characteristics.

In yet another form, the calibrated spindle tool is a tool disposed in a tool magazine of the machining tool and the tool is employed to perform a spindle runout assessment of the machining tool.

In one form, the controller is configured to perform a dynamic response assessment, a machine alignment assessment, a spindle runout assessment or a combination thereof.

In another form, the machine assessment system further includes a plurality of calibrated spindle tools. The plurality of the calibrated spindle tools includes a mandrel and a tool artifact having a known mass and damping characteristics. The mandrel is employed to perform at least one of the machine alignment assessment and the spindle runout assessment, and the tool artifact is employed to perform the dynamic response assessment.

In one form, the present disclosure is directed toward a machine assessment system for a machining tool including a spindle. The machine assessment system including a calibrated spindle tool configured to couple to a distal end of the spindle, a displacement sensor configured to measure a performance characteristic of the machining tool based on a controlled excitation of the calibrated spindle tool, a controller communicably coupled to the displacement sensor to acquire the performance characteristic, a power supply configured to provide power to at least one of the controller and the displacement sensor, and a fixture disposable on a table of the machining tool. In measuring the performance characteristic, the displacement sensor is detached from the calibrated spindle tool. The controller is configured perform a machine health assessment based on the performance characteristic. The fixture is configured to support the calibrated spindle tool, the displacement sensor, the controller, the power supply, or a combination thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a computer numeric control (CNC) machine system in accordance with the teachings of the present disclosure;

FIG. 2 illustrates a machine assessment system for performing a machine health assessment of the CNC machine in accordance with the teachings of the present disclosure; and

FIG. 3 illustrates the machine assessment system with a mandrel as a calibrated spindle tool in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

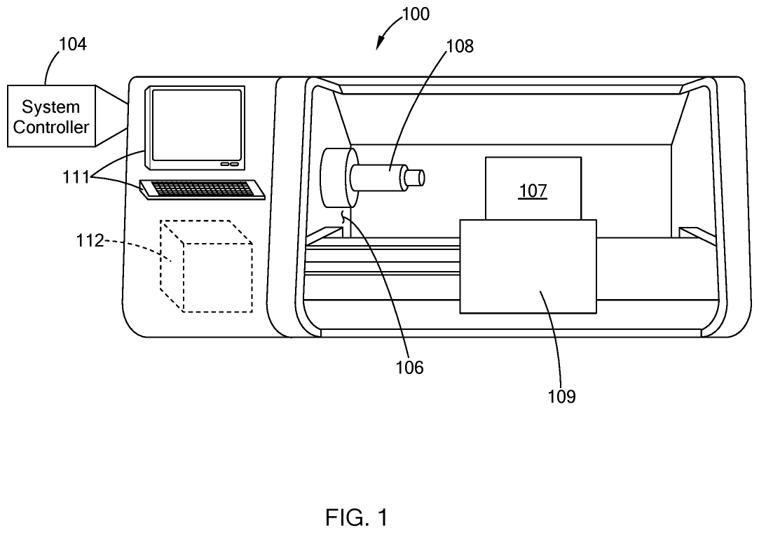

Referring to FIG. 1, a computer numeric control (CNC) machine system 100 (“CNC system”, hereinafter) includes a CNC system controller 104 and a multi-axis CNC machining center 106 (“CNC machine” hereinafter) that is operable to form a part (e.g., an engine block) out of a workpiece 107 (e.g., metal casting) disposed on a table 109 of the CNC machine 106. The CNC machine 106 includes a spindle 108 and a tool (not shown) attached to an end of the spindle 108. The tool is selected from multiple tools housed in a tool magazine 112. The spindle 108 and/or the table 109 having the workpiece 107 are moveable relative to each other along multiple axes, such that the spindle 108 aligns with a section of the workpiece 107 that is to be machined. The teachings of the present disclosure are applicable to other machines, and should not be limited to the CNC system 100 depicted.

The CNC system controller 104 is configured to operate the CNC machine 106 using one or more pre-stored programs. Accordingly, along with other components of the CNC machine 106, the CNC system controller 104 controls the torque, position, orientation, and other operation parameters of the spindle 108 in order to form the part. The CNC system controller 104 may be accessible by an operator via a user interface 111.

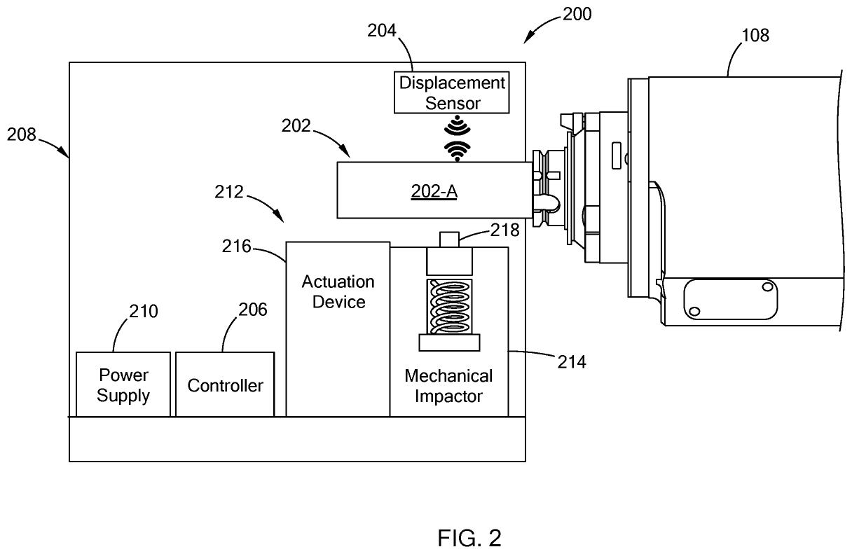

At times, one or more diagnostics or machine health assessments is performed on the CNC system 100 to determine whether the system 100 is operating within certain parameters. In one form, referring to FIG. 2, the CNC system 100 employs a machine assessment system 200 to conduct one or more machine health assessments of the CNC machine 106. The machine assessment system 200 is configured to automate testing of the CNC system 100 in order to improve accuracy of the machined health assessment(s) and reduce non-machining downtime for performing the assessment.

In one form, the machine assessment system 200 includes a calibrated spindle tool 202, a displacement sensor 204, and a controller 206. The calibrated spindle tool 202 is configured to couple to the spindle 108 (i.e., a distal end) and thus, may include structural features at one end to engage with the spindle 108. In one form, the calibrated spindle tool 202 is further adapted to measure a specific characteristic of the CNC machine 106. More particularly, in FIG. 2, the calibrated spindle tool 202 is provided as a tool artifact 202-A for performing a dynamic vibration assessment of the CNC machine 106. In one form, the tool artifact 202-A has a known mass and damping characteristics. For the dynamic vibration assessment, the tool artifact 202-A undergoes a controlled excitation causing a vibrational response of the CNC machine 106. As described further below, based on the vibration response, diagnostics may be performed to determine if the CNC machine 106 is operating within predefined parameters.

Based on the size and use, the calibrated spindle tool 202 may be stored in the tool magazine 112 of the CNC machine 106, and in the event a machine health assessment requiring the calibrated spindle tool 202 is being performed, the CNC system controller 104 operates the CNC machine 106 to retrieve the calibrated spindle tool 202 from the tool magazine 112 and attach the system 102 to the spindle 108. In another form, the calibrated spindle tool 202 is disposed with other components of the machine assessment system 200.

The displacement sensor 204 is configured to measure a performance characteristic of the CNC machine 106 based on the controlled excitation of the calibrated spindle tool 202. More particularly, the displacement sensor 204 measures movement (i.e., displacement) of the calibrated spindle tool 202 as the tool 202 undergoes the controlled excitation. The movement of the calibrated spindle tool 202 is used to measure the performance characteristics of the CNC machine 106. For example, movement of the calibrated spindle tool 202 provides a vibrational response of the CNC machine 106, alignment of the spindle 108 relative to a feed axis of the CNC machine 106, and/or radial runout of the spindle 108.

In one form, the displacement sensor 204 is a non-contact sensor and thus, is detached from the calibrated spindle tool 202 and positioned a distance from the calibrated spindle tool 202. The distance between the displacement sensor 204 and the calibrated spindle tool 202 is dependent on multiple factors including but not limited to the machine health assessment being performed, tolerance of the displacement sensor 204, stand-off distance, and/or detection range of the displacement sensor 204, among other factors. In one form, the displacement sensor 204 includes but is not limited to optical/laser displacement sensor, ultrasonic sensor, and/or other suitable non-contact displacement sensors. While one displacement sensor 204 is illustrated more than one displacement sensor 204 may be employed. In addition, different types displacement sensors 204 may be provided.

The controller 206 is configured to communicate with the displacement sensor 204 to acquire data indicative of the performance characteristic of the CNC machine 106 and perform a machine health assessment based on the performance characteristic. The controller 206 is further configured to communicate to other controllers such as the CNC system controller 104 to provide data related to the machine health assessment. The controller 206 is configured to employ one or more types of communication links to exchange data with external devices such as the displacement sensor 204 and the CNC system controller 104. For example, the controller 206 may employ wired communication using input/output interface and/or wireless communication like Bluetooth-type, Zibgee-type, and/or Message Queuing Telemetry Transport (MQTT)-type communication protocols, among others.

In one form, the controller 206 is further configured to include a library of machine health assessments to be performed by the machine assessment system 200. As an example, the machine health assessments include a dynamic response assessment, a machine alignment assessment, and/or a spindle runout assessment. Results from the machine health assessment is transmitted to the CNC system controller 104 and/or other suitable controller for further analysis. Details of regarding the machine health assessments are provided below.

The various components of the machine assessment system 200 may be provided on a fixture, generally represented by reference number 208. For example, in one form, the fixture 208 may include a pallet, brackets, shelving, and/or other suitable structural components for housing one or more components of the machine assessment system 200. In one application, the fixture 208 is designed for easy transport of components from a storage facility to the CNC machine 106 and is disposable on the table 109 of the CNC machine 106. Once positioned on the table 109, the machine assessment system 200 can be moved relative to the spindle 108.

The machine assessment system 200 may further include a power supply 210 to provide power to one or more components of the machine assessment system 200. For example, the power supply 210 supplies power to the controller 206, and/or the displacement sensor 204. In one variation, the controller 206 and/or the displacement sensor 204 may include separate power supplies such as a battery pack (not shown) that may be recharged by the power supply 210. In one form, the power supply 210 is a battery, a power converter electrically coupled to a power source power the CNC system 100, and/or other suitable power supply.

To perform certain machine health assessments, the machine assessment system 200 may include additional devices. For example, to perform dynamic response assessment, the machine assessment system 200 further includes a vibration mechanism 212 operable to exert the controlled excitation to the calibrated spindle tool 202. In one form, the vibration mechanism 212 includes a mechanical impactor 214, an actuation device 216, and a load cell 218. The mechanical impactor 214 is operable to exert a physical force upon the calibrated spindle tool 202, and may include a mechanical spring, a hydraulic pump, and/or an electronic actuator, among other mechanical devices for exerting a physical force.

The actuation device 216 is configured to operate the mechanical impactor 214 and more specifically, energizes the mechanical impactor 214 to have the mechanical impactor 214 exert the physical force on to the calibrated spindle tool 202. In one form, the actuation device 216 includes a solenoid energizeable by, for example, the power supply 210 to trigger the mechanical impactor 214 to exert the physical force. In another form, the actuation device 216 includes a spring (e.g., a torsional or linear spring) that is compressed prior to the assessment and is released to trigger the mechanical impactor 214 to exert the physical force. The spring of the actuation device 216 may be compressed by the spindle 108. Specifically, prior to coupling the calibrated spindle tool 202, a tool may be attached to the spindle 108 and is received by the actuation device 216. By rotating the tool via the spindle 108, the spring within the actuation device 216 may be compressed.

In one form, the actuation device 216 is communicably coupled to the controller 206 for receiving a command signal to operate the mechanical impactor 214. In another form, the actuation device 216 may include a start button operable by a technician to have the actuation device 216 operate the mechanical impactor 214.

The load cell 218 is disposed at the mechanical impactor 214 to measure an excitation signal indicative of the physical force exerted on the calibrated spindle tool 202. In one form, the load cell 218 is communicably coupled to the controller 206 to provide data indicative of the excitation signal. Accordingly, the controller 206 acquires the input signal exerted on to the calibrated spindle tool 202 and the associated vibrational response.

As provided above, the machine assessment system 200 is configured to perform one or more machine health assessments of the CNC machine 106. For the dynamic response assessment, the calibrated spindle tool 202, such as the tool artifact 202-A, is positioned in the spindle 108 and undergoes a physical impact as the controlled excitation by the vibration mechanism 212. The displacement sensor 204 is configured to measure a vibrational response of the calibrated spindle tool 202 (i.e., displacement) and more particularly, the CNC machine 106. The vibrational response is provided as the performance characteristic of the CNC machine 106. The controller 206 receives data indicative of the vibrational response as a dynamic response signal from the displacement sensor 204. In addition to the dynamic response signal, the controller 206 receives data indicative of the excitation signal exerted on to the calibrated spindle tool 202 from the load cell 218. As part of the machine health assessment, the controller 206 is configured to transform the dynamic response signal to a frequency domain signal and apply one or more filters to the transformed signal. For example, the transformed signal is transposed from its measured location (i.e., position of the displacement sensor 204) to a desired location (e.g., an end of the spindle 108). The controller 206 may also process the excitation signal to transform the data to a frequency domain. In one form, the controller 206 transmits signals indicative of the processed excitation signal and the processed dynamic response signal to the CNC system controller 104 or another controller as a machine vibration data for further evaluation.

For the machine alignment assessment, the machine assessment system 200 analyzes the alignment between a rotational axis of spindle 108 and the feed axis of the CNC machine 106. Misalignment of the spindle may be also referred to as spindle “crabbing.” Previous techniques for measuring misalignment include “tramming” a precision mandrel in which a radial deviation of an indicator fixed to the CNC machine 106 is recorded as the indicator traverses the mandrel along the feed direction. This and other methods could require significant downtime. Unlike such labor intensive measuring methods, the machine assessment system 200 measures alignment using the displacement sensor 204 and the calibrated spindle tool 202.

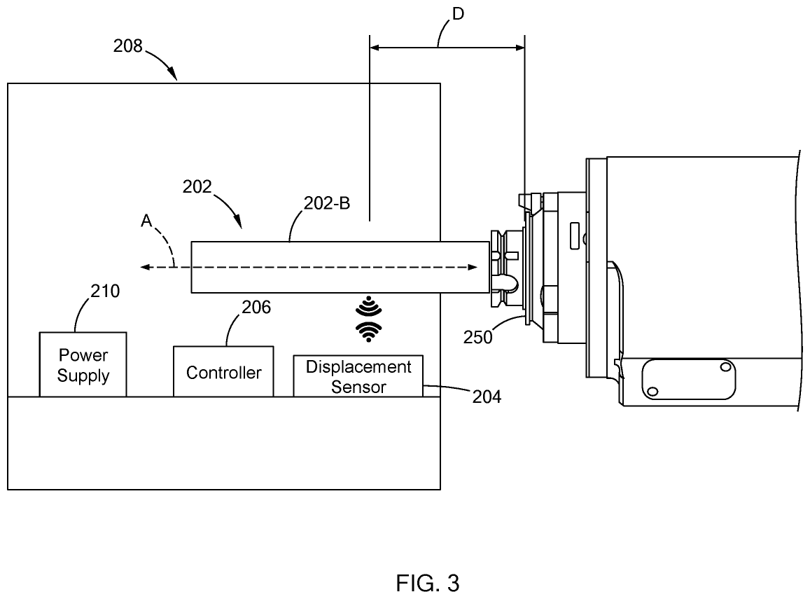

More particularly, referring to FIG. 3, the machine assessment system 200 includes a mandrel 202-B, as the calibrated spindle tool 202. In one form, the mandrel 202-B is a ground steel longitudinal bar (e.g., roughly 300 mm long and 50 mm in diameter) with one end configured to connect to the spindle 108. The mandrel 202-B may be stored in a holding structure provided on the fixture 208 to provide easy access and setup for the machine alignment assessment. While specific dimensions are provided, the mandrel 202-B may be configured in various suitable ways and should not be limited to the example provided herein.

With mandrel 202-B attached and the fixture 208 having the displacement sensor 204 positioned on the table 109 of the CNC machine 106, the displacement sensor 204 traverses the mandrel 202-B along the feed axis (axis A in FIG. 3) and measures displacement of the mandrel 202-B as it traverses. For example, the displacement sensor 204 may first be positioned near a nose of the spindle 108 (i.e., where the mandrel 202-5 and the spindle 108 are connected) and then the displacement sensor 204 moves along the feed axis while aligned with and measuring the displacement of the mandrel 202-B for a defined lateral distance (e.g., 250 mm). The measured displacement is provided as a function of axial position. In one form, the CNC machine 106 moves the fixture 208 via the table 109 to have the displacement sensor 204 traverse the mandrel 202-B. In another form, the table 109 may be fixed and the spindle 108 having the mandrel 202-B may move relative to the displacement sensor 204. The displacement sensor 204 transmits the data to the controller 206 which in return is configured to calculate a misalignment error of the spindle 108. The controller 206 may transmit the misalignment error to the CNC system controller 104 and/or other controller for further analysis. In addition, in one form, based on the misalignment error, the CNC machine 106 is further calibrated to correct the misalignment. Controlled displacement between the displacement sensor 204 and the mandrel 202-B is provided as a controlled excitation of the mandrel 202-B (i.e., the calibrated spindle tool 202) and the displacement data of the mandrel 202-B is the performance characteristic of the CNC machine 106.

Using the mandrel 202-B, the machine assessment system 200 may also perform the spindle runout assessment. Specifically, with the mandrel 202-B attached to the spindle 108 and the fixture 208 having the displacement sensor 204 provided on the table 109, the CNC machine 106 is controlled so as to position the displacement sensor 204 a defined distance (e.g., distance “D” in FIG. 3) from a front surface 250 of the spindle 108. The spindle 108 is then controlled to rotate the mandrel 202-B at a low speed (e.g., 5 rotation-per-minute) and the displacement sensor 204 measures displacement of the mandrel 202-B as it is rotating. The displacement data is then transmitted to the controller 206, which in return transforms the data into frequency domain and determines a runout of the spindle 108 by detecting, for example, spikes in the data. Displacement data may be measured for more than one axial position (i.e., more than one defined distance from the front surface 250). The controller 206 may then transmit the data to the CNC system controller 104 and/or other controller for further processing. For the spindle runout assessment, the rotational movement of the mandrel 202-B is provided as a controlled excitation of mandrel 202-B (i.e., the calibrated spindle tool 202) and the displacement of the mandrel 202-B which is indicative of spindle runout is the performance characteristic of the CNC machine 106. In lieu of the mandrel 202-B, the machine assessment system 200 may employ a tool from the tool magazine for performing the spindle runout assessment.

While specific numerical examples are provided above for the machine health assessments, other values may be used and should not limited to the examples provided. In one form, the operation of the CNC machine 106 for each of the health assessments may be preprogrammed in the CNC system controller 104, such that once the fixture 208 having the supporting components of the machine assessment system (e.g., displacement sensor, controller, and/or power supply) is provided and the spindle 108 is coupled to the calibrated spindle tool 202, the CNC system controller 104 may execute a series of programs to move the spindle 108 and/or table 109 based on the assessment being performed. Alternatively, a technician may operate the CNC machine 106 in a manual mode to move the spindle 108 and/or the table 109.

Using the data from the controller 206, an external controller (e.g., the CNC system controller 104 and/or other controller) may assess the health of the CNC machine 106. For example, based on data for the vibration assessment, the external controller performs a frequency response function (FRF) measurement to determine stability lobes of the CNC machine 106. In addition, the frequency at which the machine condition (e.g., irregular vibrational response, misalignment, and/or runout) occurs can be monitored with predefined parameters like date, machining cycle, machining operations to determine possible correlation.

The machine assessment system of the present disclosure is configured to perform one or more machine health assessments that is easily accessible and adaptable to the machine system being evaluated. The machine assessment system improves efficiency and accuracy of the assessment by using controllable and adjustable devices like but not limited to the vibration mechanism, the displacement sensor, and/or the controller, among others. Data regarding these assessments can be further analyzed and stored by external controllers.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A machine assessment system for a machining tool including a spindle, the machine assessment system comprising:
a calibrated spindle tool configured to couple to a distal end of the spindle;
a displacement sensor configured to measure a performance characteristic of the machining tool based on a controlled excitation of the calibrated spindle tool, wherein, in measuring the performance characteristic, the displacement sensor is detached from the calibrated spindle tool; and
a controller communicably coupled to the displacement sensor to acquire the performance characteristic, wherein the controller is configured perform a machine health assessment based on the performance characteristic.

2. The machine assessment system of claim 1 further comprising a vibration mechanism operable to exert the controlled excitation to the calibrated spindle tool.

3. The machine assessment system of claim 2, wherein the vibration mechanism includes:
a mechanical impactor operable to exert a physical force upon the calibrated spindle tool:
an actuation device configured to operate the mechanical impactor, wherein the actuation device energizes the mechanical impactor to have the mechanical impactor exert the physical force; and
a load cell disposed at the mechanical impactor to measure an excitation signal indicative of the physical force, wherein the load cell is communicably coupled to the controller to provide the excitation signal.

4. The machine assessment system of claim 3, wherein the actuation device includes a solenoid energizeable by a power supply to trigger the mechanical impactor to exert the physical force in response to being energized.

5. The machine assessment system of claim 3, wherein the actuation device includes a spring to trigger the mechanical impactor to exert the physical force in response to being energized.

6. The machine assessment system of claim 3, wherein the performance characteristic of the machining tool is indicative of a vibrational response of the machining tool due to the physical force exerted by the mechanical impactor.

7. The machine assessment system of claim 3, wherein the mechanical impactor includes at least one of a mechanical spring, a hydraulic pump, and an electronic actuator.

8. The machine assessment system of claim 1 further comprising a power supply configured to provide power to at least one of the controller and the displacement sensor.

9. The machine assessment system of claim 1 further comprising a fixture configured to support at least one of the controller, the displacement sensor, and the calibrated spindle tool, wherein the fixture is configured to mount at the machining tool for the machine health assessment.

10. The machine assessment system of claim 1, wherein the calibrated spindle tool is a mandrel to perform at least one of alignment assessment and spindle runout assessment of the machining tool.

11. The machine assessment system of claim 1, wherein the calibrated spindle tool is a tool artifact to perform a dynamic vibration assessment of the machining tool, wherein the tool artifact has a known mass and damping characteristics.

12. The machine assessment system of claim 1, wherein the calibrated spindle tool is a tool disposed in a tool magazine of the machining tool and the tool is employed to perform a spindle runout assessment of the machining tool.

13. The machine assessment system of claim 1, wherein the controller is configured to perform a dynamic response assessment, a machine alignment assessment, a spindle runout assessment or a combination thereof.

14. The machine assessment system of claim 13 further comprising a plurality of calibrated spindle tools, wherein:
the plurality of the calibrated spindle tools includes a mandrel and a tool artifact having a known mass and damping characteristics, and
the mandrel is employed to perform at least one of the machine alignment assessment and the spindle runout assessment, and
the tool artifact is employed to perform the dynamic response assessment.

15. A machine assessment system for a machining tool including a spindle, the machine assessment system comprising:
a calibrated spindle tool configured to couple to a distal end of the spindle;
a displacement sensor configured to measure a performance characteristic of the machining tool based on a controlled excitation of the calibrated spindle tool, wherein, in measuring the performance characteristic, the displacement sensor is detached from the calibrated spindle tool;
a controller communicably coupled to the displacement sensor to acquire the performance characteristic, wherein the controller is configured perform a machine health assessment based on the performance characteristic;
a power supply configured to provide power to at least one of the controller and the displacement sensor; and
a fixture disposable on a table of the machining tool, wherein the fixture is configured to support the calibrated spindle tool, the displacement sensor, the controller, the power supply, or a combination thereof.

16. The machine assessment system of claim 15 further comprising a vibration mechanism operable to exert the controlled excitation to the calibrated spindle tool.

17. The machine assessment system of claim 16, wherein the vibration mechanism includes:
a mechanical impactor operable to exert a physical force upon the calibrated spindle tool:
an actuation device configured to operate the mechanical impactor, wherein the actuation device energizes the mechanical impactor to have the mechanical impactor exert the physical force; and
a load cell disposed at the mechanical impactor to measure an excitation signal indicative of the physical force, wherein the load cell is communicably coupled to the controller to provide the excitation signal.

18. The machine assessment system of claim 15, wherein the controller is configured to perform a dynamic response assessment, a machine alignment assessment, a spindle runout assessment or a combination thereof.

19. The machine assessment system of claim 18 further comprising a plurality of calibrated spindle tools, wherein:
the plurality of the calibrated spindle tools includes a mandrel and a tool artifact having a known mass and damping characteristics, and
the mandrel is employed to perform at least one of the machine alignment assessment and the spindle runout assessment, and
the tool artifact is employed to perform the dynamic response assessment.

20. The machine assessment system of claim 15, wherein the calibrated spindle tool is a tool disposed in a tool magazine of the machining tool and the tool is employed to perform a spindle runout assessment of the machining tool.
